(19) United States
(12) Patent Application Publication
(10) Pub. No.: US 2024/0385494 A1
(43) Pub. Date: Nov. 21, 2024

(54) OPTICAL COUPLING DEVICE AND RESPECTIVE METHOD FOR TUNING

(71) Applicant: PHOTONPATH S.R.L, Milano (IT)

(72) Inventors: Alessandro PERINO, MILANO (IT); Elena DAMIANI, MILANO (IT); Douglas OLIVEIRA MORAIS DE AGUIAR, MILANO (IT); Emanuele GUGLIELMI, MILANO (IT)

(21) Appl. No.: 18/696,554

(22) PCT Filed: Sep. 26, 2022
(86) PCT No.: PCT/IT2022/050258

§ 371 Date: Mar. 28, 2024

(30) Foreign Application Priority Data
Sep. 30, 2021 (IT) 102021000025166

(51) Int. Cl. G02F 1/313; G02B 6/12; G02F 1/025; G02F 1/21

(52) U.S. Cl. CPC G02F 1/3133; G02F 1/025; G02F 1/212; G02B 6/12; G02B 2006/12061; G02B 2006/12097; G02B 2006/12147

(57) ABSTRACT

Optical coupling device (99) and method for tuning the device, the device comprising a pair of optical waveguides (1, 2) mutually optically coupled at respectively a first (3) and a second optical coupling tract (7), the first optical waveguide (1) comprising a first (4) and a second region (5) having type of doping different from each other and a reciprocal interface (6) at least partially arranged at the first optical coupling tract (3), wherein the device (99) comprises a first electrode (8) and a second electrode (9) electrically connected to the first optical waveguide (1) at opposite sides of the interface, the method comprising applying an electric voltage difference between the first (8) and second electrode (9) to apply an electric field to the interface (6), introducing an input optical signal, adjusting a value of the electric voltage difference for vary a ratio between optical powers of a pair of output optical signals.

### TECHNICAL FIELD OF THE INVENTION

The present invention relates to an optical coupling device and a respective method for tuning said device.

### STATE OF THE ART

The present invention is placed in the field of photonics, that is the set of the technologies and of the methods for the generation, transmission, processing and reception of optical signal.

The term “optical” refers to an electromagnetic radiation that falls within a broadened neighbourhood of the visible optical band, and does not necessarily falling strictly within the visible optical band (i.e. indicatively 400-700 nm), for example this broadened neighbourhood of the visible optical band typically comprises the near infrared (for example wavelength between about 700 nm to about 2 μm).

In the field of photonics, optical coupling devices are known, in which an optical signal entering an input port is divided into two distinct optical signals, each exiting from a respective output port.

In one embodiment, an optical coupling device may comprise a pair of optical waveguides optically coupled to each other at a coupling region.

Tunable optical coupling devices are also known, in which a ratio between the optical powers of the two output optical signals (splitting ratio) can be dynamically varied, at a given wavelength (up to including the case of a ratio that goes from 0-100 to 100-0), and/or the wavelength at which a given ratio between the optical powers is obtained can be varied.

By the term “doping” it is meant, in the field of the semiconductors, the addition to the pure semiconductor (also called “intrinsic”) of variable percentages of atoms of elements different with respect to the pure semiconductor (e.g. silicon, silicon carbide), in order to modify the physical properties of the material constituting the pure semiconductor. Typically, the doping improves the electric conductivity of the pure semiconductor. The types of doping are commonly two and are defined respectively as “n” type and “p” type. The types of doping and the operational properties that such types of doping confer to the pure semiconductor are known per se and will not be further described. In the context of the present invention, the expression “type of doping” also comprises the case in which the semiconductor is pure (i.e. absence of doping), for a total of three types of doping.

The document JP2014182185A discloses an optical switch in the form of a Mach-Zehnder interferometer (MZI), comprising two optical coupling devices (e.g. 3 dB splitter/couplers) and two optical paths connecting the two optical coupling devices to each other. This MZI is tuned by injection of an electric current at one of the two optical paths, causing a change of the refractive index.

### SUMMARY OF THE INVENTION

The Applicant has found that a tunable optical coupling device based on a Mach-Zehnder interferometer has some disadvantages.

First of all, the structure itself of the MZI is complex, since, for example, it has to comprise the two optical coupling devices and the two optical connection paths. The necessary presence of the aforementioned parts also entails a large spatial encumbrance (or footprint) by the MZI.

The Applicant has therefore faced the problem of realizing an optical coupling device capable of being tuned in efficient way (i.e. with a little electrical consumption) and which is at the same time structurally simple, and/or cheap and/or with limited spatial encumbrance.

According to the Applicant the above problem is solved by an optical coupling device and by a method for tuning said device according to the attached claims and/or having one or more of the following features.

According to an aspect the invention relates to an optical coupling device.

The device comprises:
a first optical waveguide made of semiconductor having a first input and a first output;
a second optical waveguide having a second input and a second output;
   wherein said first and second optical waveguide are mutually optically coupled at respectively a first and a second optical coupling tract respectively interposed between said first input and first output and between said second input and second output, wherein said first optical waveguide comprises a first and a second region having a respective type of doping different from each other and having a reciprocal interface, wherein said device comprises a first electrode and a second electrode electrically connected to the first optical waveguide at opposite sides of said interface and wherein said interface is at least partially arranged at said first optical coupling tract.

According to an aspect the invention relates to a method for tuning an optical coupling device. The method comprises:
providing said optical coupling device according to the present invention;
applying an electric voltage difference between said first and second electrode to apply to said interface an electric field;
introducing an optical signal as input to said first input;
adjusting a value of said electric voltage difference to vary a ratio between optical powers of a first optical signal exiting from said first output and a second optical signal exiting from said second output.

According to the Applicant, the first and the second region of the first optical waveguide having different types of doping between each other (including the case where one of the first and second regions is devoid of doping, i.e. intrinsic) and with reciprocal interface at least partially at the first optical coupling tract, allow to substantially realize a diode with the junction at such interface, i.e. in the first optical coupling tract. In this way, thanks to the electric field applied to the interface between the first and the second region, it is possible to adjust, as the sign and/or the value of the electric voltage applied to the electrodes vary, the density of free charge carriers (e.g. electrons and/or holes) in the first and in the second region, for example by varying the spatial extension of the depletion region of the diode and/or by injecting new charge carriers (e.g. by injection of electric current). The adjustment of the density of free charge carriers in turn allows to be able to dynamically vary the optical refractive index of at least a portion of the optical coupling tract of the first optical waveguide arranged at the interface between the two regions (as known from the Kramers-Kronig relation and the Soref equations), thus allowing the tuning of the coupling device itself (in the form of a pair of optical waveguides). In this way, a tunable optical coupling device is realized with a simplified structure with respect to the structure of an MZI, with consequent lower costs and/or smaller spatial encumbrance.

The Applicant has thus overcome a common prejudice in the field of photonics according to which an MZI structure was necessary in order to create a tunable optical coupling device since only in this case it was possible to arrange the electrodes by exploiting the space available at one of the two respective optical paths (i.e. away from the two, typically 3 dB, fixed optical coupling devices). On the contrary, the present invention contemplates the tuning of the single optical coupling device in the form of a pair of optically coupled optical waveguides, creating a diode at the first optical coupling tract.

By “substantially perpendicular” with reference to geometric elements (such as straight lines, planes, surfaces etc.) it is meant that these elements form an angle of 90°+/−15°, preferably of 90°+/−10°.

By “substantially parallel” with reference to the aforementioned geometric elements it is meant that these elements form an angle of 0°+/−15°, preferably of 0°+/−10°.

The present invention in one or more of the above aspects may exhibit one or more of the following preferred features.

Typically, each optical coupling tract has main development along a longitudinal direction.

Preferably said interface is substantially entirely arranged at said first optical coupling tract. In this way the interface is effectively arranged for the tuning purpose.

Preferably said second optical waveguide is made of semiconductor. In this way the optical waveguides can be made with the same technology, to the advantage of the simplicity of the device.

Preferably said first and second optical waveguides each comprise a respective main development line (e.g. a line of path of the optical signal).

Preferably said first and second electrode are in (direct) electric contact with said first and second region respectively. In this way the application of the electric field to the interface is made effective.

Preferably a density of doping of at least one of, more preferably of both, said first and second region at a respective contact area with respectively said first and second electrode is greater than a density of doping of a remaining part of the respective region. In this way, a reservoir for the charge carriers is created and/or the electric contact between electrodes and optical waveguide is improved.

Preferably said density of doping of the first and/or second region at the respective contact area is greater than or equal to 10¹⁵ atoms/cm³, more preferably greater than or equal to 10¹⁷ atoms/cm³, and/or less than or equal to 10²¹ atoms/cm³, more preferably less than or equal to 10²⁰ atoms/cm³. Preferably said density of doping of the remaining part of the first and/or second region is greater than or equal to 10¹⁴ atoms/cm³, more preferably greater than or equal to 10¹⁶ atoms/cm³, and/or less than or equal to 10¹⁸ atoms/cm³, more preferably less than or equal to 10¹⁷ atoms/cm³.

Such densities of doping are particularly suitable for the transmission of electric currents while limiting the manufacturing costs and/or potential disturbances to the propagation of the optical signal.

Preferably said first optical waveguide is a rib waveguide at least at said first and second electrode. Preferably said rib waveguide has section, on a plane (substantially) perpendicular to said main development line, which comprises a central portion and a first and a second lateral portion arranged at opposite sides of, and in continuity with, said central portion and having lower height with respect to the central portion.

Preferably each of said first and second electrode is in (direct) electric contact with at least one of said first and second lateral portion. In this way, the lateral portions provide sufficient space to arrange the electrodes while limiting interference with the optical signal.

Preferably said second optical waveguide comprises a respective first and second region having a respective type of doping different from each other and having a respective reciprocal interface at least partially arranged at the second optical coupling tract. In this way, also for the second optical waveguide, a diode is created with the junction at the optical coupling tract in order to be able to tune the device also by means of the second optical waveguide (in addition to the first optical waveguide, as described below).

In a first embodiment said first and second electrode are arranged (i.e. they directly contact the first optical waveguide) at longitudinally opposite sides of, and externally to, said first optical coupling tract. In this way it is possible to adjust the concentration of free charge carriers at the optical coupling tract while keeping limited the structural complexity of the device (e.g. with respect to other positioning of the interface). Furthermore, the shape of the guides at the contact point leaves sufficient space for the electrodes.

Preferably said interface of the first optical waveguide develops (substantially) perpendicularly to said longitudinal direction (i.e. the interface is—substantially-transverse). In this way it is rationally arranged according to the positioning of the electrodes. By the term “transverse” and the like, it is meant a direction substantially perpendicular to the longitudinal direction.

Preferably each of said first and second electrode is in (direct) electric contact with both said first and second lateral portion. In this way the intensity and/or uniformity of the electric field is improved.

Preferably said first and second optical waveguide are mutually electrically insulated. In this way the second optical waveguide is prevented from being affected by the two electrodes during tuning.

Preferably said first optical waveguide (more preferably each optical waveguide) is a channel waveguide at (entirely) said first (and respectively second) optical coupling tract. In this way the aforesaid electrical insulation is achieved in a constructively simple way.

Preferably said lateral portions of said section of the first optical waveguide taper towards the central portion moving along said main development line from said contact area towards said first optical coupling tract. In this way the transition zone from “rib waveguide” to “channel waveguide” is effectively realized.

Preferably said device comprises a third electrode and a fourth electrode electrically connected to said second optical waveguide at opposite sides of said interface of the second optical waveguide.

Preferably said third and fourth electrode are arranged (i.e. they directly contact said second optical waveguide) at longitudinally opposite sides of, and externally to, said second optical coupling tract. Preferably also said interface of the second optical waveguide develops (substantially) perpendicularly to the longitudinal direction.

Preferably said method comprises applying a respective electric voltage difference between said third and fourth electrode to apply to said interface of the second optical waveguide a respective electric field. Preferably said method comprises adjusting a value of said respective electric voltage difference between said third and fourth electrode to vary said ratio between the optical powers. In this way it is possible to vary the refractive index also of the second waveguide.

Preferably said method comprises applying said electric voltage difference between said first and second electrode with opposite sign with respect to said respective electric voltage difference applied between said third and fourth electrode. In this way it is possible to vary the density of the free charge carriers in the first optical waveguide with opposite trend with respect to the variation of the density of free charge carriers of the second optical waveguide, to obtain a desired difference between the two values of density of carriers. In this way, it is possible to obtain a difference between the two values of density of carriers (and therefore of the refractive index) globally greater (e.g. with respect to the case of variation by electric voltage applied to a single optical waveguide). Furthermore, for a given difference of density of carriers, each density of free charge carriers can assume a lower absolute value, reducing power consumption. In a second embodiment said first optical waveguide is a rib waveguide at said first optical coupling tract, said first electrode being in (direct) electric contact with said first lateral portion externally to the first optical coupling tract, said first lateral portion facing the second optical waveguide, and said second electrode being in (direct) electric contact with said second lateral portion at the first optical coupling tract. In this way it is possible to adjust the density of free charge carriers while keeping limited the electric voltage difference applied to the electrodes (e.g. since it is possible to limit the distance between electrodes and interface). Furthermore, the shape of the waveguide provides space for the electrodes.

Preferably said interface of the first optical waveguide develops (substantially) parallelly to said longitudinal direction. In this way it is rationally positioned.

Preferably said interface develops along substantially all said first optical coupling tract. In this way the variation of the refractive index affects the whole first optical coupling tract, to the advantage of the tuning efficiency.

Preferably said first optical waveguide is entirely a rib waveguide. In this way the device is simplified.

Preferably said interface is arranged in proximity to, or at, said central portion of the section of the first optical waveguide. In this way the variation efficiency of the refractive index is further improved (e.g. by variation of the spatial extension of the depletion region which, for a given electric voltage applied to the electrodes, can affect in spatially wider way the portion of optical waveguide in which the optical signal is substantially entirely transmitted).

Preferably said first electrode comprises (at least) two sub-electrodes respectively arranged at longitudinally opposite sides of the first optical coupling tract. In this way, applying a same electric voltage to the longitudinally opposite ends of the interface, the uniformity and/or intensity of the electric field is improved, for example at the longitudinal centre of the interface.

Preferably said second electrode comprises a plurality of sub-electrodes distinct from each other and longitudinally distributed (preferably mutually equidistant) along at least part of, more preferably substantially all, said first optical coupling tract. In this way the electrical contact is further improved.

Preferably also said second optical waveguide is a rib waveguide at said second optical coupling tract (more preferably each first and second optical waveguide is entirely a rib waveguide). In this way the device is simplified.

Preferably said first optical (rib) waveguide has said first lateral portion in common with a first lateral portion of said second optical waveguide at least at the respective first and second optical coupling tract (the first lateral portions facing each other). In this way the device is compact.

Preferably said first electrode is in (direct) electric contact with said first lateral portion in common in proximity (and externally) to said first and second optical coupling tract. In this way the first electrode is also in electric contact with the second optical waveguide.

Preferably the first regions of the first and of the second optical waveguide respectively are continuous to each other (e.g. they constitute a single first region), and more preferably comprise (entirely) said first lateral portion in common. Preferably the first regions of the first and of the second optical waveguide have a same type of doping, and more preferably a same density of doping. In this way the realization of the first regions is simplified.

Preferably the second optical waveguide has one or more of the features of the first optical waveguide. In this way the device is rational.

Preferably said device comprises a further electrode electrically connected to said second optical waveguide at opposite side of the interface of the second optical waveguide with respect to said first electrode. Preferably said method comprises applying a respective electric voltage difference between said first and further electrode to apply to said interface of the second optical waveguide a respective electric field. Preferably said method comprises adjusting a value of said respective electric voltage difference between said first and further electrode to vary said ratio between the optical powers. In this way it is possible to tune the device by also operating on the second optical waveguide, increasing the tuning efficiency.

Preferably said method comprises applying said electric voltage difference between said first and second electrode with opposite sign with respect to said respective electric voltage difference applied between said first and further electrode. In this way the variations of density of the free charge carriers in the two optical waveguides are opposite to each other, with the same effect as described above.

Preferably said further electrode is in (direct) electric contact with said second lateral portion of the second optical waveguide at the second optical coupling tract. In this way it is rationally arranged.

Preferably also the interface of the second optical waveguide develops (substantially) parallelly to the longitudinal direction. In this way the tuning is simplified.

Preferably each electrode has section that tapers moving towards respectively said first or second optical waveguide. In this way the electric contact is favoured.

Preferably said device comprises a longitudinal plane of symmetry. In this way the device is versatile and optically symmetrical.

Preferably said device comprises a transverse plane of symmetry (substantially) perpendicular to said longitudinal plane of symmetry. In this way the functioning of the device is improved.

Preferably said device comprises a layer of electrically insulating material (e.g. silicon oxide). Preferably said layer substantially entirely surrounds (e.g. with exception of the electrode areas) said first and second optical waveguide. In this way the device is robust and an electrical separation between the optical waveguides (at least in the first embodiment) is achieved.

### BRIEF DESCRIPTION OF THE DRAWINGS

FIG. 1 schematically shows a top view of a first embodiment of the device according to the present invention;

FIG. 2 schematically shows a section along the plane AA of FIG. 1;

FIG. 3 schematically shows a section along the plane BB of FIG. 1;

FIG. 4 schematically shows a top view of a second embodiment of the device according to the present invention;

FIG. 5 schematically shows a section along the plane CC of FIG. 4;

FIG. 6 schematically shows a section along the plane DD of FIG. 4.

### DETAILED DESCRIPTION OF SOME EMBODIMENTS OF THE INVENTION

The features and the advantages of the present invention will be further clarified by the following detailed description of some embodiments, presented by way of non-limiting example of the present invention, with reference to the attached figures (not to scale).

In the figures, the number 99 globally indicates an optical coupling device.

The device 99 exemplarily comprises a first optical waveguide 1 made of semiconductor (e.g. silicon, silicon carbide, etc.) having a first input 10 and a first output 11, and a second optical waveguide 2 made of semiconductor having a second input 20 and a second output 21.

Exemplarily the first 1 and the second optical waveguide 2 are mutually optically coupled at respectively a first 3 and a second optical coupling tract 7 respectively interposed between the first input 10 and the first output 11 and between the second input 20 and the second output 21. Exemplarily the optical coupling tracts 3, 7 have main development along a longitudinal direction 100.

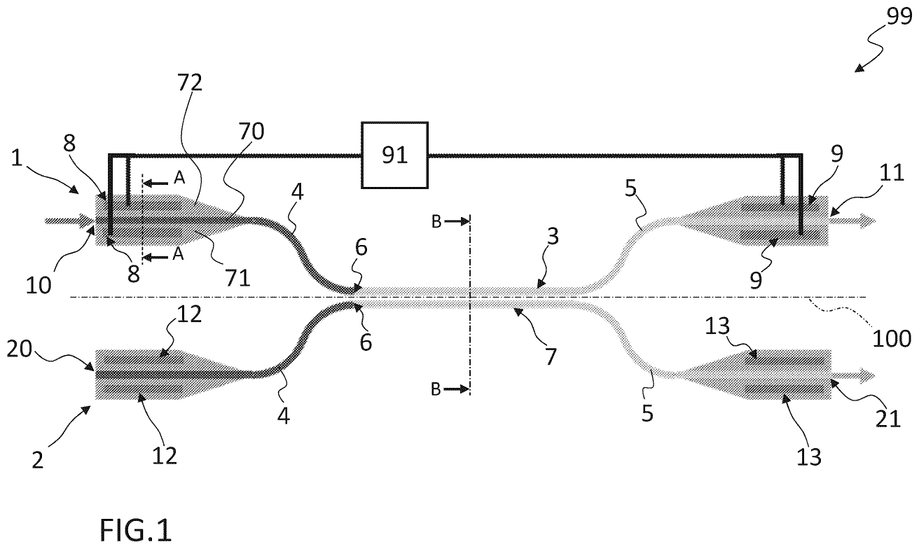

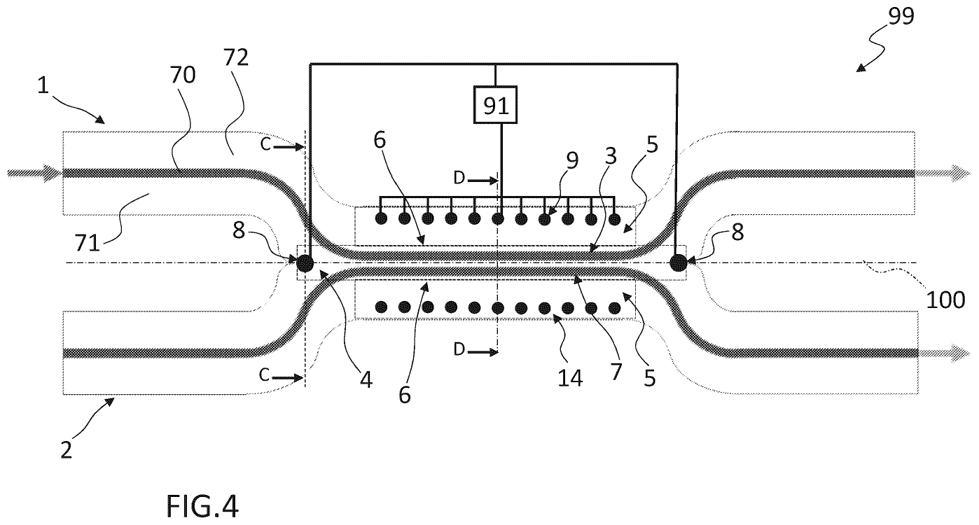

Exemplarily the device 99 comprises a longitudinal plane of symmetry (which crosses the plane of FIGS. 1 and 4 along the longitudinal direction 100), and a transverse plane of symmetry perpendicular to the longitudinal plane of symmetry (in FIGS. 1 and 4 respectively coinciding with the section planes BB and DD).

Exemplarily each optical waveguide 1, 2 comprises a first 4 and a second region 5 having a respective type of doping different from each other (n, p or intrinsic), and having a respective interface 6 substantially entirely arranged at respectively the first 3 and the second optical coupling tract 7.

Exemplarily the device 99 comprises a first electrode 8 and a second electrode 9 arranged in direct electric contact respectively with the first 4 and the second region 5 of the first optical waveguide 1 at opposite sides of the interface 6 of the first optical waveguide.

In a first embodiment, shown in FIGS. 1-3, the first 8 and the second electrode 9 are exemplarily arranged at longitudinally opposite sides of, and externally to, the first optical coupling tract 3. Exemplarily each interface 6 develops perpendicularly to the longitudinal direction 100 so that the respective first and second regions are entirely longitudinally opposite to each other.

In one embodiment (not shown) each interface 6 can define any angle with respect to the longitudinal direction (e.g. 45°) and/or have shape different from the planar one shown in the figures.

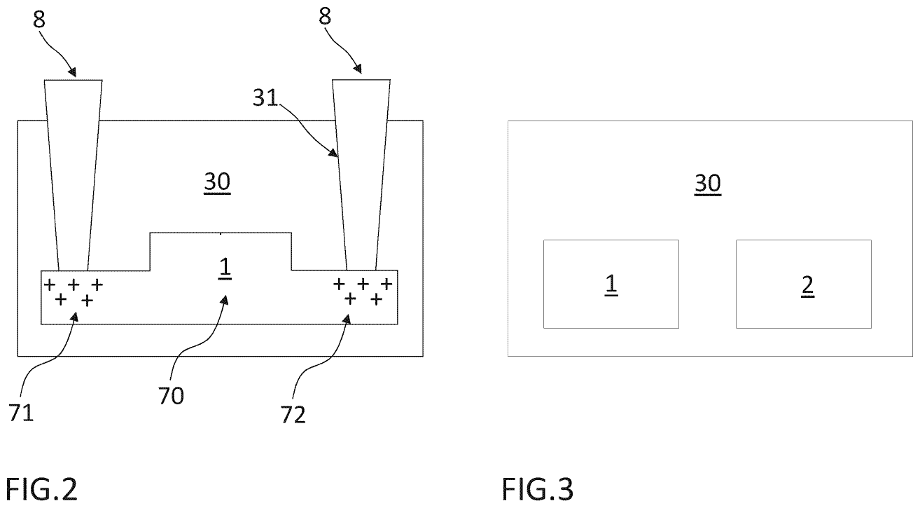

In the first embodiment the first optical waveguide 1 is exemplarily a rib waveguide only at the contact area with the first 8 and the second electrode 9. The rib waveguide (FIG. 2) exemplarily has section, in a plane perpendicular to a main development line of the optical waveguide (e.g. plane AA), which comprises a central portion 70 and a first 71 and a second lateral portion 72 arranged at opposite sides of, and in continuity with, the central portion 70 and having lower height with respect to the central portion 70 (i.e. the section has an inverted T profile).

Exemplarily both the first 8 and the second electrode 9 are in direct electric contact with both the first 71 and the second lateral portion 72 of the first optical waveguide. In the first embodiment (FIG. 1) the device 99 exemplarily comprises a third 12 and a fourth electrode 13 in direct electric contact with respectively the first 4 and the second region 5 of the second optical waveguide 2 at opposite sides of the interface 6 of the second optical waveguide 2.

Exemplarily the third 12 and the fourth electrode 13 are arranged at longitudinally opposite sides of, and externally to, the second optical coupling tract 7.

Exemplarily also the second optical waveguide is a rib waveguide only at a respective contact area with the third 12 and fourth electrode 13, the third 12 and the fourth electrode 13 being in direct electric contact with both the first 71 and the second lateral portion 72 of the second optical waveguide.

In the first embodiment, the first 1 and the second optical waveguide 2 are mutually electrically insulated, and, to this end, both are exemplary a channel waveguide, shown in section in FIG. 3, at least at the entire respective optical coupling tract 3, 7.

Exemplarily, as shown in FIG. 1, the lateral portions 71, 72 of both the optical waveguides taper towards the respective central portion 70 proceeding along a main development line of the respective optical waveguide, from the respective contact area with the electrode towards the respective optical coupling tract 3, 7.

Advantageously, at the optical coupling tracts 3, 7, each optical waveguide 1, 2 has in the same cross-sectional shape (FIG. 3) as the respective central portion 70.

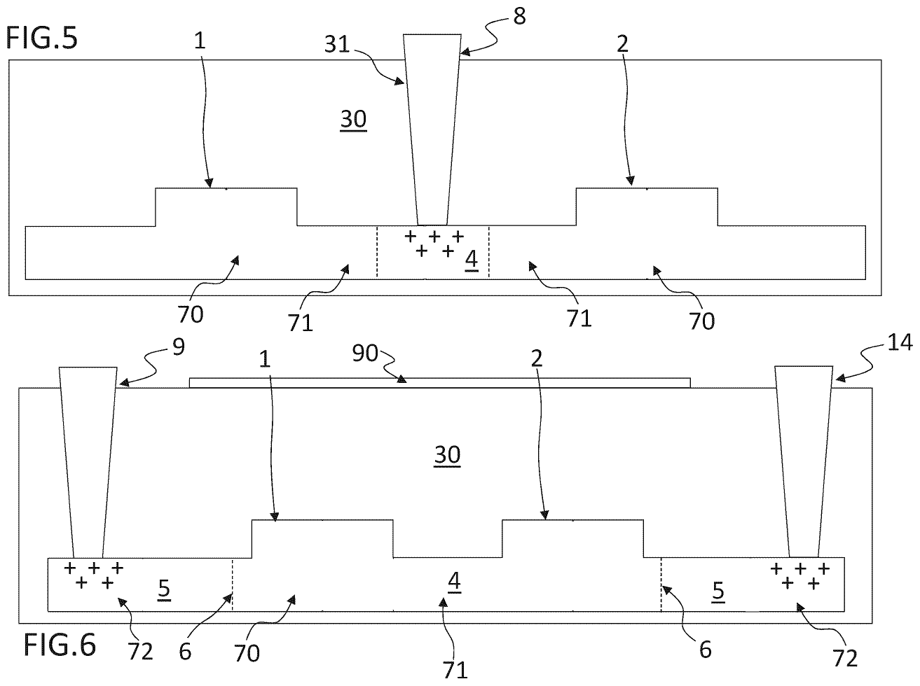

In the second embodiment, shown in FIGS. 4-6, each interface 6 develops parallelly to the longitudinal direction 100 for substantially all the respective optical coupling tract 3, 7. In other words the respective first and second region are entirely transversely opposite.

In the second embodiment, each optical waveguide 1, 2 is entirely a rib waveguide having the respective first lateral portion 71 facing the other optical waveguide.

In the second embodiment the first optical waveguide 1 exemplarily has the first lateral portion 71 in common with the first lateral portion 71 of the second optical waveguide 2 at the respective optical coupling tracts 3, 7 and also beyond, and in proximity to, such optical coupling tracts.

Exemplarily the first regions 4 of the first 1 and of the second optical waveguide 2, respectively, constitute a single continuous first region 4, having a single type and density of doping and partially comprising the first lateral portion 71 in common (FIGS. 1 and 6).

Exemplarily each interface 6 is arranged in proximity to the central portion 70 of the respective optical waveguide, externally to the first lateral portion in common (i.e. at the second lateral portion 72 of the respective optical waveguide).

In one embodiment (not shown), the interfaces can be arranged in proximity to the respective central portion, inside the first lateral portion in common.

In a further embodiment (not shown), the interfaces can be arranged at (inside the) respective central portion.

Exemplarily the first electrode 8 is in direct electric contact with the first lateral portion 71 in common of the two optical waveguides, in proximity to, and externally to, the first and second optical coupling tract. Exemplarily, in the second embodiment, the first electrode is therefore in direct electric contact also with the first region 4 of the second optical waveguide 2. Exemplarily the first electrode 8 comprises two sub-electrodes arranged respectively at longitudinally opposite sides of the first 3 and of the second optical coupling tract 7 and in substantially equidistant position from the central portions 70 of the first 1 and second optical waveguide 2.

In the second embodiment, FIG. 4, the second regions 5 of the first 1 and of the second optical waveguide 2 exemplarily develop at the second lateral portions 72 of the respective optical waveguide at substantially all the respective optical coupling tract 3, 7. In this way, if the second region is n or p doped, the extent of the doping is limited in order to reduce costs.

In the second embodiment, the second electrode 9 is exemplarily in direct electric contact with the second lateral portion 72 of the first optical waveguide 1, the second electrode 9 exemplarily comprising a plurality of sub-electrodes distinct from each other and longitudinally distributed, mutually equidistant, along substantially all the first optical coupling tract 3.

In the second embodiment, the device 99 comprises a further electrode 14 in direct electric contact with the second lateral portion 72 of the second optical waveguide 2 at opposite side of the interface 6 of the second optical waveguide 2 with respect to the first electrode 8. In the second embodiment the further electrode 14 is exemplarily specular to the second electrode 9 with respect to the longitudinal plane of symmetry.

In both the embodiments, a density of doping of the first 4 and of the second region 5 of both the optical waveguides at each respective contact area with a respective electrode (schematically indicated by the + signs in the figures) is exemplarily greater than a density of doping of the remaining part of the respective region.

Exemplarily the density of doping of the first 4 and of the second region 5 at the respective contact area with the electrode is equal to about 10¹⁹ atoms/cm³, and the density of doping of the remaining part is about 10¹⁶ atoms/cm³.

Exemplarily each electrode 8, 9, 12-14 is made of electrically conductive material (e.g. metal) and has section that tapers moving respectively towards the first 1 and/or the second optical waveguide 2.

Exemplarily the device 99 comprises a layer 30 of electrically insulating material (e.g. silicon oxide), which substantially entirely surrounds the first 1 and the second optical waveguide 2.

Exemplarily the layer 30 comprises, for each electrode 8, 9, 12-14 an opening 31 which houses the respective electrode and allows the electric contact with the respective optical waveguide. Exemplarily each opening is counter-shaped to the respective electrode (i.e. there is no space between electrode and walls of the opening). For example, during manufacturing, the layer 30 is perforated and entirely filled with the metal (e.g. by known micro and/or nanofabrication techniques).

Optionally, the device 99 comprises an electrically conductive plate 90 (exemplarily shown in conjunction with the second embodiment, FIG. 6) having a face facing the first 1 and the second optical waveguide 2 at the optical coupling tracts of the optical waveguides, wherein a free distance is maintained between the optical waveguides and the plate 90 (the plate exemplarily being resting on the layer 30).

Exemplarily the plate 90 is placed at a constant electric potential. The plate exemplarily allows to be able to attract and/or reject further free charge carriers in/from the portions of optical waveguide 1, 2 at the plate, to vary a density of doping of the optical waveguides and therefore their electric conductivity.

In use, the device 99 exemplarily allows to divide an optical signal entering the first input 10, in a pair of optical signals exiting respectively from the first output 11 and from the second output 21 (in the figures the optical signals are represented by oriented arrows).

Optionally (not shown), an optical signal can be fed into the second input and divided between the outputs.

Exemplarily the device 99 can be tuned to dynamically vary the ratio between the optical powers of the signals exiting respectively from the first output 11 and from the second output 21.

Exemplarily, in both the embodiments, to tune the device 99 it is provided applying an electric voltage difference between the first 8 and the second electrode 9 to apply an electric field to the interface 6 of the first optical waveguide 1, and adjusting a value of the electric voltage difference to vary the aforementioned ratio between optical powers.

Exemplarily, FIGS. 1 and 4 schematically show a voltage generator 91 electrically connected to the first 8 and the second electrode 9 to apply the aforementioned electric voltage difference.

In the first embodiment, it can also be exemplarily provided (optional, not shown) applying a respective electric voltage difference between the third 12 and the fourth electrode 13 to apply a respective electric field to the interface 6 of the second optical waveguide 2.

Preferably it is provided applying the electric voltage difference between the first 8 and the second electrode 9 with opposite sign with respect to the respective electric voltage difference applied between the third 12 and the fourth electrode 13. For example, with the first region 4 p-doped and the second region 5 n-doped for both the optical waveguides, the first optical waveguide (which operatively behaves like a diode) can be operated in direct voltage (i.e. first electrode 8 at positive potential, second electrode 9 at negative potential), and the second optical waveguide (also operationally comparable to a diode) can be operated in reverse voltage (i.e. third electrode 12 at negative potential and fourth electrode 13 at negative potential). With such connection, by applying voltage, the density of free charge carriers of the first optical waveguide is increased by injection of electric current, while the density of free charge carriers of the second optical waveguide is decreased by widening of the spatial extension of the depletion region of the diode, even up to include the entire second optical waveguide. In this way the densities of free charge carriers of the two optical waveguides are varied in mutual opposite directions, improving the tuning efficiency. Alternatively, the opposite connection to that described above is also possible.

In the second embodiment, it can be exemplarily provided (optional, not shown) applying a respective electric voltage difference between the first 8 and the further electrode 14 to apply a respective electric field to the interface 6 of the second optical waveguide 2, and adjusting a value of the respective electric voltage difference between the first and the further electrode to vary the aforementioned ratio between the optical powers.

Preferably, also in the second embodiment, it is provided applying the electric voltage difference between the first and second electrodes with opposite sign with respect to the respective electric voltage difference applied between the first and the further electrode (to obtain the same result as described above).

1. An optical coupling device comprising:
a first optical waveguide made of semiconductor having a first input and a first output;
a second optical waveguide having a second input and a second output;
wherein said first and second optical waveguide are mutually optically coupled at respectively a first and a second optical coupling tract respectively interposed between said first input and first output and between said second input and second output,
wherein said first optical waveguide comprises a first and a second region having a respective type of doping different from each other and having a reciprocal interface,
wherein said device comprises a first electrode and a second electrode electrically connected to the first optical waveguide at opposite sides of said interface and
wherein said interface is at least partially arranged at said first optical coupling tract.

2. The device according to claim 1, wherein said first and second electrode are arranged at longitudinally opposite sides of, and externally to, said first optical coupling tract, said first and second optical coupling tract having main development along a longitudinal direction.

3. The device according to claim 2, wherein said interface develops substantially perpendicularly to said longitudinal direction and along substantially all said first optical coupling tract, wherein said first optical waveguide is a rib waveguide at least at said first and second electrode, wherein said rib waveguide has section, on a plane substantially perpendicular to a main development line of the first optical waveguide, which comprises a central portion and a first and a second lateral portion arranged at opposite sides of, and in continuity with, said central portion and having lower height with respect to the central portion, wherein each of said first and second electrode is in electric contact with at least one of said first and second lateral portion, wherein said first and second optical waveguide are mutually electrically insulated, and wherein said first optical waveguide is a channel waveguide at said first optical coupling tract.

4. The device according to claim 2, wherein said second optical waveguide comprises a respective first and second region having a respective type of doping different from each other and having a respective reciprocal interface at least partially arranged at the second optical coupling tract, wherein said device comprises a third electrode and a fourth electrode electrically connected to said second optical waveguide at opposite sides of said interface of the second optical waveguide, wherein said third and fourth electrode are arranged at longitudinally opposite sides of, and externally to, said second optical coupling tract, and wherein said interface of the second optical waveguide develops substantially perpendicularly to said longitudinal direction.

5. The device according to claim 1, wherein said first optical waveguide is a rib waveguide at said first optical coupling tract, wherein said rib waveguide has section, on a plane substantially perpendicular to a main development line of the first optical waveguide, which comprises a central portion and a first and a second lateral portion arranged at opposite sides of, and in continuity with, said central portion and having lower height with respect to the central portion, said first electrode being in electric contact with said first lateral portion externally to the first optical coupling tract, said first lateral portion facing the second optical waveguide, and said second electrode being in electric contact with said second lateral portion at the first optical coupling tract.

6. The device according to claim 5, wherein said interface develops substantially parallelly to a longitudinal direction of main development of said first and second optical coupling tract and along substantially all said first optical coupling tract, wherein said interface is arranged in proximity to, or at, said central portion, wherein said first electrode comprises at least two sub electrodes respectively arranged at longitudinally opposite sides of the first optical coupling tract, and wherein said second electrode comprises a plurality of sub electrodes distinct from each other and longitudinally distributed along at least part of said first optical coupling tract.

7. The device according to claim 5, wherein the second optical waveguide comprises a respective first and second region having a respective type of doping different from each other and having a respective reciprocal interface at least partially arranged at the second optical coupling tract, wherein also said second optical waveguide is a rib waveguide at said second optical coupling tract, wherein said first optical waveguide has said first lateral portion in common with a first lateral portion of said second optical waveguide at least at the respective first and second optical coupling tract, wherein said first electrode is in electric contact with said first lateral portion in common in proximity to, and externally to, said first and second optical coupling tract, wherein said device comprises a further electrode electrically connected to said second optical waveguide at opposite side of the interface of the second optical waveguide with respect to said first electrode, said further electrode being in electric contact with a second lateral portion of the second optical waveguide at the second optical coupling tract, and wherein also the interface of the second optical waveguide develops substantially parallelly to said longitudinal direction.

8. The device according to claim 1, comprising a longitudinal plane of symmetry and a transverse plane of symmetry, wherein a density of doping of at least one of said first and second region of at least one of said first and second optical waveguide at a respective contact area with a respective electrode is greater than a density of doping of a remaining part of the respective region, wherein said density of doping of the first and/or second region at the respective contact area is greater than or equal to 10¹⁵ atoms/cm³ and less than or equal to 10²¹ atoms/cm³, and wherein said density of doping of the remaining part of the first and/or second region is greater than or equal to 10¹⁴ atoms/cm³ and less than or equal to 10¹⁸ atoms/cm³.

9. A method for tuning an optical coupling device, the method comprising:
providing said optical coupling device according to claim 1;
applying an electric voltage difference between said first and second electrode to apply an electric field to said interface of the first optical waveguide;
introducing an optical signal as input to said first input;
adjusting a value of said electric voltage difference to vary a ratio between optical powers of a first optical signal exiting from said first output and a second optical signal exiting from said second output.

10. The method according to claim 9, comprising:
applying a respective electric voltage difference between said third and fourth electrode, or between said first and further electrode, to apply to said interface of the second optical waveguide a respective electric field;
adjusting a value of said respective electric voltage difference between said third and fourth electrode, or between said first and further electrode, to vary said ratio between the optical powers,
wherein said method further comprises applying said electric voltage difference between said first and second electrode with opposite sign with respect to said respective electric voltage difference applied between said third and fourth electrode, or between said first and further electrode.
